(19) United States
(12) Patent Application Publication
(10) Pub. No.: US 2023/0178738 A1
(43) Pub. Date: Jun. 8, 2023

(54) ELECTRODE FOR LITHIUM ION BATTERY AND METHOD OF MANUFACTURING ELECTRODE FOR LITHIUM ION BATTERY

(71) Applicant: TOYOTA JIDOSHA KABUSHIKI KAISHA, Toyota-shi (JP)

(72) Inventors: Masashi UEDA, Toyota-shi (JP); Sokichi OKUBO, Okazaki-shi (JP); Takuo YANAGI, Toyota-shi (JP)

(73) Assignee: TOYOTA JIDOSHA KABUSHIKI KAISHA, Toyota-shi (JP)

(21) Appl. No.: 17/946,549

(22) Filed: Sep. 16, 2022

(30) Foreign Application Priority Data
Dec. 3, 2021 (JP) 2021-196822

(51) Int. Cl. H01M 4/62; H01M 4/04; H01M 4/139

(52) U.S. Cl. CPC H01M 4/621; H01M 4/0404; H01M 4/139

(57) ABSTRACT

An electrode for a lithium ion battery includes a current collector foil, binder particle groups, and an active material layer. The binder particle groups are attached to a surface of the current collector foil. The active material layer is arranged on the surface of the current collector foil. The active material layer contains active material particle groups. The binder particle groups are scattered within an interface between the active material layer and the current collector foil.

### CROSS-REFERENCE TO RELATED APPLICATION

This application claims priority to Japanese Patent Application No. 2021-196822 filed on Dec. 3, 2021, incorporated herein by reference in its entirety.

### BACKGROUND

### 1. Technical Field

The present disclosure relates to an electrode for a lithium ion battery and a method of manufacturing the electrode.

### 2. Description of Related Art

Japanese Unexamined Patent Application Publication No. 2016-122631 (JP 2016-122631 A) discloses the formation of a binder coat layer on a current collector.

### SUMMARY

An electrode for a lithium ion battery (hereinafter, can be simply described as “electrode”) can be manufactured by forming an active material layer on the surface of a current collector foil. In order to increase peel strength between the active material layer and the current collector foil, forming a binder film between the active material layer and the current collector foil is considered.

Conventionally, a binder film is formed by a wet method. That is, the binder film is formed by coating a surface of a current collector foil with a binder solution. The binder film coats the surface of the current collector foil. A binder is a resistance component. The interposition of the binder film between the current collector foil and the active material layer possibly leads to an increase in interfacial resistance (electronic resistance) between the current collector foil and the active material layer.

The present disclosure reduces the increase in interfacial resistance.

Hereinafter, the technical configuration and operation and effect of the present disclosure will be described. Here, the mechanism of action of the present specification includes an assumption. The mechanism of action does not limit the technical scope of the present disclosure.

An electrode for a lithium ion battery according to a first aspect of the present disclosure includes a current collector foil, binder particle groups, and an active material layer. The binder particle groups are attached to a surface of the current collector foil. The active material layer is arranged on the surface of the current collector foil. The active material layer contains active material particle groups. The binder particle groups are scattered within an interface between the active material layer and the current collector foil.

According to the first aspect of the present disclosure, the binder particle groups are scattered within the interface between the active material layer and the current collector foil. The binder is in the form of particles instead of being in the form of a film. Therefore, within the interface between the active material layer and the current collector foil, a large number of active material particles can have points of contact with the current collector foil. Accordingly, the increase in interfacial resistance resulting from the use of the binder can be reduced.

It is considered that in a case where the binder film is formed on the surface of the current collector foil, the number of points of contact between the binder film (surface) and the active material particles is likely to be reduced. In contrast, binder particles can come into point-contact with active material particles. Because the binder is in the form of particles, the point of contact between the binder and the active material particles can be increased. Using binder particle groups instead of a binder film is expected to make it possible to obtain a high peel strength with a low binder basis weight.

In the first aspect of the present disclosure, a fraction of an area to which the binder particle groups are attached in an area of the current collector foil may be 11.4% to 19.3%.

According to the first aspect of the present disclosure, hereinafter, “fraction of an area to which the binder particle groups are attached in an area of the current collector foil” may be simply described as “area fraction”. In a case where the area fraction is 11.4% or more, the peel strength is expected to be improved. In a case where the area fraction is 19.3% or less, the interfacial resistance is expected to be reduced.

In the first aspect of the present disclosure, D50 of the binder particle groups may be smaller than D50 of the active material particle groups.

According to the first aspect of the present disclosure, the size of the binder particles is smaller than the size of the active material particles, which can increase the points of contact between the active material particles and the current collector foil. It is expected that, as a result, the interfacial resistance will be reduced.

In the first aspect of the present disclosure, the binder particle groups may have a basis weight of 0.010 mg/cm² to 0.017 mg/cm².

A method of manufacturing an electrode for a lithium ion battery according to a second aspect of the present disclosure includes the following steps (a) to (c).

(a) Preparing a current collector foil,
(b) coating a surface of the current collector foil with binder particle groups by a dry method; and
(c) forming an active material layer by coating the surface of the current collector foil with active material particle groups after the step (b).

According to the second aspect of the present disclosure, the coating with the binder particle groups by a dry method does not form a binder film and allows the binder particle groups to be scattered.

In the second aspect of the present disclosure, the step (b) may include attaching the binder particle groups to the surface of the current collector foil by electrostatic force.

As an example of the dry method, a method of attaching the binder particle groups to the current collector foil by electrostatic force is considered.

In the second aspect of the present disclosure, the step (c) may include performing coating with the active material particle groups by a dry method.

For example, in a case where the coating with the active material particle groups is performed by a wet method, the arrangement of the binder particle groups is likely to change. It is considered that performing the coating with the active material particle groups by a dry method will make it easy to maintain the way the binder particle groups are scattered.

Hereinafter, embodiments of the present disclosure (hereinafter, can be simply described as “the present embodiment”) and examples of the present disclosure (hereinafter, can be simply described as “the present example”) will be described. Here, the present embodiment and the present example do not limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual cross-sectional view of an electrode for a lithium ion battery according to the present embodiment;

FIG. 2 is a conceptual top view of binder particle groups;

FIG. 3 is a conceptual top view of a binder film;

FIG. 4 is a conceptual cross-sectional view of the binder film;

FIG. 5 is a schematic flowchart of a method of manufacturing an electrode for a lithium ion battery in the present embodiment;

FIG. 6 is a conceptual view showing an example of a coating method of binder particle groups;

FIG. 7 is a graph showing the relationship between binder basis weight and interfacial resistance; and

FIG. 8 is a graph showing the relationship between binder basis weight and peel strength.

### DETAILED DESCRIPTION OF EMBODIMENTS

### Definition of Terms, and the Like

In the present specification, “including”, “containing”, “having”, and descriptions which are modifications (for example, “composed of” or the like) of “including”, “containing”, and “having” are an open-ended form. The open-ended form may or may not include additional elements in addition to essential elements. The description “consisting of” is a closed form. However, even in the closed form, additional elements that are usually accompanying impurities or irrelevant to the technique of the present disclosure art not excluded. The description of “substantially consists of” is a semi-closed form. In the semi-closed form, the addition of elements that substantially do not affect the basic and novel characteristics of the technique of the present disclosure is acceptable.

In the present specification, the expressions such as “may” and “can” do not mean “must” which signifies requisiteness, and are used to mean “be likely to” which signifies acceptability.

In the present specification, unless otherwise specified, a numerical range such as “m % to n %” includes an upper limit and a lower limit. That is, “m % to n %” represents a numerical range of “m % or more and n % or less”. “m % or more and n % or less” includes “more than m % and less than n %”. A numerical value arbitrarily selected from a numerical range may be adopted as a new upper or lower limit. For example, a new numerical range may be set by arbitrarily combining a numerical value within a numerical range with a numerical value described in another part, table, or drawing in the present specification.

In the present specification, all numerical values are modified by the term “about”. The term “about” can mean, for example, ±5%, ±3%, ±1%, and the like. All numerical values can be approximate values that can change depending on the mode of use of the technique of the present disclosure. All numerical values can be expressed in significant figures. A measured value can be an average of values obtained by measurement performed multiple times. The number of times of measurement may be 3 or more, 5 or more, or 10 or more. Generally, it is expected that the reliability of the average will be improved as the number of times of measurement increases. The measured value can be rounded off to the nearest integer based on number of digits of the significant figures. The measured value can include, for example, an error that occurs due to the detection limit of the measuring device or the like.

In the present specification, in a case where a compound is represented by a stoichiometric composition formula (for example, “LiCoO₂”), the stoichiometric composition formula is merely a typical example of the compound. The compound may have a non-stoichiometric composition. For example, in a case where lithium cobalt oxide is represented by “LiCoO₂”, unless otherwise specified, the lithium cobalt oxide is not limited to the composition ratio of “Li/Co/O=1/1/2”, and can contain Li, Co, and O at any composition ratio. Doping or substitution with trace elements and the like are also acceptable.

Unless otherwise specified, the aforementioned order of executing a plurality of steps, motions, and operations included in various methods and the like are not limited to the order described in the present specification. For example, a plurality of steps may be simultaneously performed. For example, a plurality of steps may be substantially simultaneously performed.

In the present specification, “electrode” is a generic term for a positive electrode and a negative electrode. The electrode may be a positive or negative electrode.

“D50” in the present specification represents a particle size at which a cumulative frequency of particles having a particle size smaller than D50 reaches 50% in a volume-based particle size distribution. The volume-based particle size distribution can be obtained, for example, by a laser diffraction scattering method.

In the present specification, “dry method” represents a coating method using a coating material having a solid fraction of 90% or more. The solid fraction of the coating material in the dry method may be, for example, 95% to 100%. “Wet method” represents a coating method using a coating material having a solid fraction less than 90%. The solid fraction of the coating material in the wet method may be, for example, 50% to 85%. “Solid fraction” represents a fraction of mass of solid components in the total mass of the coating material.

Electrode for Lithium Ion Battery

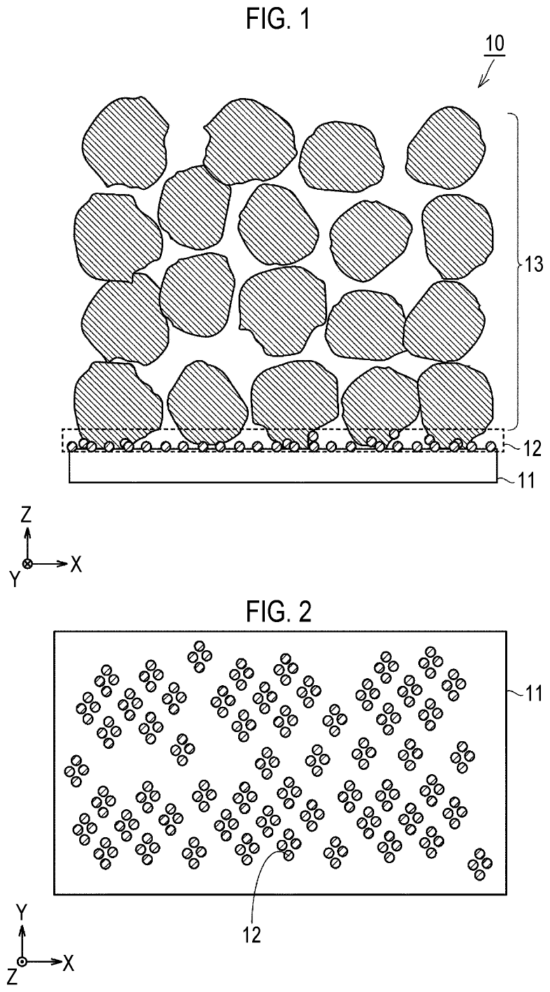

FIG. 1 is a conceptual cross-sectional view of an electrode for a lithium ion battery in the present embodiment. Hereinafter, “electrode for a lithium ion battery in the present embodiment” can be simply described as “the present electrode”. The present electrode 10 is in the form of a sheet. The present electrode 10 includes a current collector foil 11, binder particle groups 12, and an active material layer 13. The binder particle groups 12 and the active material layer 13 may be arranged on only one surface of the current collector foil 11 or may be arranged on both the front and back surfaces of the current collector foil 11.

The present electrode 10 can have a high peel strength. The peel strength between the active material layer 13 and the current collector foil 11 may be, for example, 1 N/m or more. The peel strength between the active material layer 13 and the current collector foil 11 may be, for example, 1 N/m to 3.5 N/m. The present electrode 10 can have a low interfacial resistance. The interfacial resistance between the active material layer 13 and the current collector foil 11 may be, for example, 0.0033 Ω/cm² or less. The interfacial resistance between the active material layer 13 and the current collector foil 11 may be, for example, 0.0011 Ω/cm² to 0.0033 Ω/cm².

Current Collector Foil

The current collector foil 11 has conductivity. The current collector foil 11 is in the form of a sheet. The current collector foil 11 supports the active material layer 13. The current collector foil 11 includes a metal foil. The current collector foil 11 may include, for example, at least one foil selected from the group consisting of an aluminum foil, an aluminum alloy foil, a copper foil, a copper alloy foil, a nickel foil, a titanium foil, and a stainless steel foil. The thickness of the current collector foil 11 may be, for example, 5 μm to 50 μm or 10 μm to 25 μm.

Binder Particle Groups

The binder particle groups 12 are scattered within the interface between the active material layer 13 and the current collector foil 11. FIG. 2 is a conceptual top view of the binder particle groups. The binder particle groups 12 are attached to a surface of the current collector foil 11. Within the surface of the current collector foil 11, the binder particle groups 12 are distributed in the form of islands. Each island-shaped portion may be a single binder particle or an aggregate of a plurality of binder particles. The distribution of the island-shaped portions may be regular or random. It is considered that in the void between the island-shaped portions, the active material particles can come into contact with the current collector foil 11. The size of a void between the island-shaped portions may be, for example, equal to or larger than the size of one binder particle.

Within the surface of the current collector foil 11, the basis weight of the binder particle groups 12 may be, for example, 0.010 mg/cm² to 0.017 mg/cm². The basis weight represents the mass (attached amount) per unit area. The basis weight of the binder particle groups 12 may be, for example, 0.010 mg/cm² to 0.014 mg/cm² or a 0.014 mg/cm² to 0.017 mg/cm².

Within the surface of the current collector foil 11, the area fraction of the binder particle groups 12 may be, for example, 50% or less, 30% or less, or 20% or less. The area fraction of the binder particle groups 12 may also be, for example, 11.4% to 19.3%. In a case where the area fraction is 11.4% or more, the peel strength is expected to be improved. In a case where the area fraction is 19.3% or less, the interfacial resistance is expected to be reduced. The area fraction of the binder particle groups 12 may be, for example, 11.4% to 15.9% or 15.9% to 19.3%.

The area fraction can be determined by the following Formulas (I) to (IV).

M=c×S₀ (I)

V=M÷ρ (II)

S₁=V÷T (III)

F=S₁÷S₀×100 (IV)

“M” represents the mass [mg] of the binder particle groups.

“c” represents the basis weight [mg/cm²] of the binder particle groups.

“S₀” represents the area [cm²] of the current collector foil.

“V” represents the volume [cm³] of the binder particle groups.

“ρ” represents the density [g/cm³] of the binder particle groups.

“T” represents the coating thickness [μm] of the binder particle groups.

“F” represents the area fraction [%].

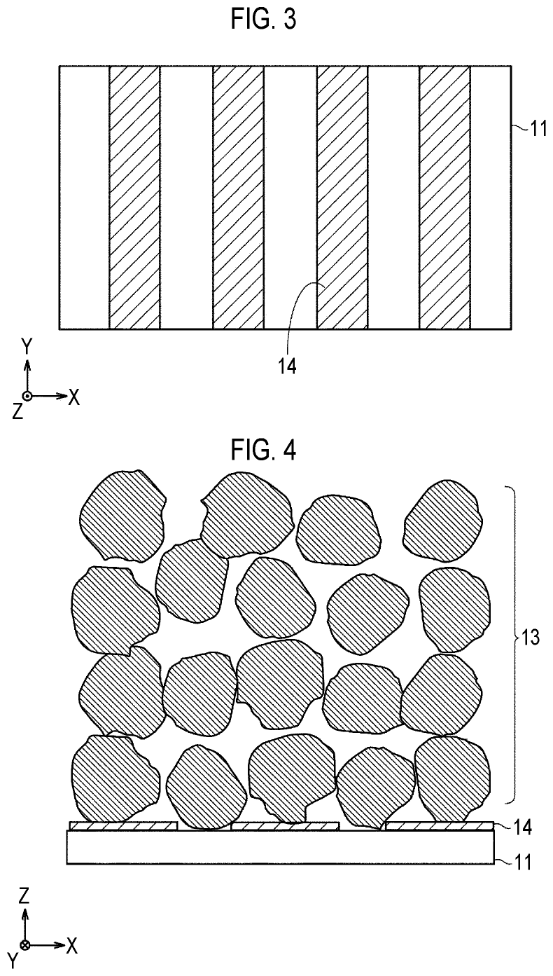

FIG. 3 is a conceptual top view of a binder film. A binder film 14 coats the surface of the current collector foil 11. In order to form points of contact between the active material particles and the current collector foil 11, for example, arranging the binder film 14 in the form of stripes is considered.

FIG. 4 is a conceptual cross-sectional view of the binder film. In voids between the binder films 14, the active material particles come into contact with the current collector foil 11. It is considered that the active material particles arranged on the binder film 14 may be difficult to come into contact with the current collector foil 11. It is considered that the desired interfacial resistance cannot be obtained even though the binder film 14 is formed in the form of stripes.

Each of the binder particle groups 12 is an aggregate of a plurality of binder particles. D50 of the binder particle groups 12 may be, for example, 10 nm to 1,000 nm, 50 nm to 500 nm, or 100 nm to 200 nm. D50 of the binder particle groups 12 may be smaller than D50 of the active material particle groups. Because the size of the binder particles is smaller than the size of the active material particles, the points of contact between the active material particles and the current collector foil 11 can be increased. It is expected that, as a result, the interfacial resistance will be reduced. D50 of the binder particle groups 12 may be equal to or less than 1/10 of D50 of the active material particle groups or equal to or less than 1/20 of D50 of the active material particle groups. D50 of the binder particle groups 12 may be equal to or more than 1/100 of D50 of the active material particle groups.

The binder particles can contain optional components. The binder particles contain, for example, at least one component selected from the group consisting of polyvinylidene fluoride (PVdF), a vinylidene fluoride-hexafluoropropylene copolymer (PVdF-HFP), styrene butadiene rubber (SBR), carboxymethyl cellulose (CMC), polyacrylic acid (PAA), polyamide-imide, (PAI) and polyimide (PI).

Active Material Layer

The active material layer 13 is arranged on the surface of the current collector foil 11. The thickness of the active material layer 13 may be, for example, 10 μm to 500 μm or 50 μm to 200 μm. The active material layer 13 contains active material particle groups. The active material layer 13 may further contain a conductive material, a binder, a solid electrolyte, and the like, in addition to the active material particle groups.

### Active Material Particle Groups

Each of the active material particle groups is an aggregate of a plurality of active material particles. D50 of the active material particle groups may be, for example, 1 μm to 30 μm or 3 μm to 10 μm.

The active material particles may contain, for example, a positive electrode active material. The active material particles may contain, for example, at least one material selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” shows that the total composition ratio of the material in the parentheses is 1. As long as the total composition ratio is 1, the amount of each component can be arbitrarily set. Li(NiCoMn)O₂ may include, for example, Li(Ni_{1/3}Co_{1/3}Mn_{1/3})O₂, Li(Ni_{0.5}Co_{0.2}Mn_{0.3})O₂, and Li(Ni_{0.8}Co_{0.1}Mn_{0.1})O₂.

The active material particles may contain, for example, a negative electrode active material. The active material particles may contain at least one material selected from the group consisting of, for example, graphite, soft carbon, hard carbon, silicon, silicon oxide, a silicon-based alloy, tin, tin oxide, a tin-based alloy, and Li₄Ti₅O₁₂.

Other Components

The active material layer 13 may further contain a binder. The mixing amount of the binder may be, for example, 0.1 parts by mass to 10 parts by mass with respect to 100 parts by mass of the active material particle groups. The binder contained in the active material layer 13 may be in the form of particles or a film. The binder may contain, for example, PVdF, CMC, and SBR.

The active material layer 13 may further contain a conductive material. The mixing amount of the conductive material may be, for example, 0.1 parts by mass to 10 parts by mass with respect to 100 parts by mass of the active material particle groups. The conductive material may include, for example, conductive carbon particles and conductive carbon fibers. The conductive material may include, for example, at least one material selected from the group consisting of carbon black, vapor grown carbon fibers, carbon nanotubes, and graphene flakes. The carbon black may include, for example, at least one material selected from the group consisting of acetylene black, furnace black, channel black, and thermal black.

The active material layer 13 may further contain a solid electrolyte. The solid electrolyte includes, for example, at least one electrolyte selected from the group consisting of Li₂S—P₂S₅, LiI—Li₂S—P₂S₅, LiBr—Li₂S—P₂S₅, and LiI—LiBr—Li₂S—P₂S₅.

Combining

For example, the active material particles and other solid materials (such as a binder and a conductive material) may be combined. For example, the active material particles and other solid materials may be mixed together under a condition where shearing force is applied, so that composite particles are formed. In the composite particles, for example, a binder and a conductive material may be attached to the surface of each of the active material particles.

Method of Manufacturing Electrode for Lithium Ion Battery

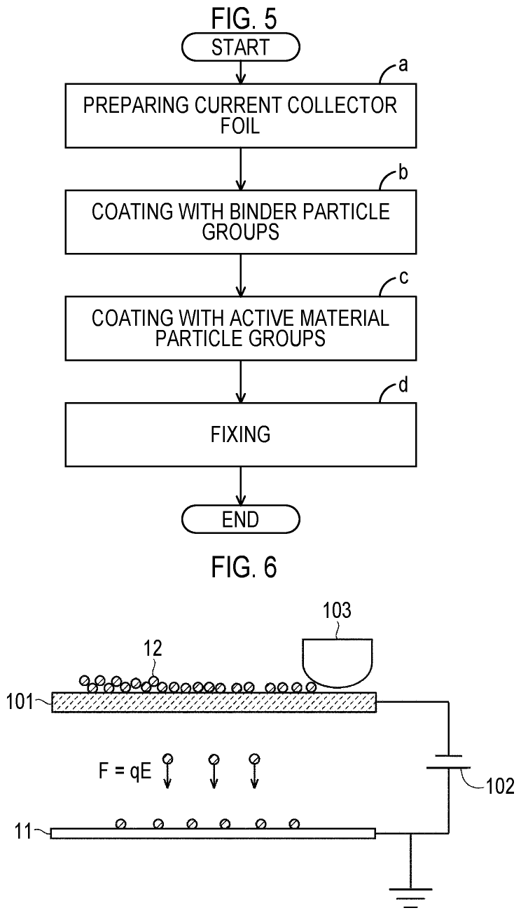

FIG. 5 is a schematic flowchart of a method of manufacturing an electrode for a lithium ion battery in the present embodiment. Hereinafter, “method of manufacturing an electrode for a lithium ion battery in the present embodiment” can be simply described as “the present manufacturing method”. The present manufacturing method includes “(a) preparing current collector foil”, “(b) coating with binder particle groups”, and “(c) coating with active material particle groups”. The present manufacturing method may further include, for example, “(d) fixing”.

(a) Preparing Current Collector Foil

The present manufacturing method includes preparing the current collector foil 11. The details of the current collector foil 11 are as described above.

(b) Coating with Binder Particle Groups

The present manufacturing method includes coating a surface of the current collector foil 11 with the binder particle groups 12 (powder) by a dry method. For example, an electrostatic printing technique, an electrostatic coating technique, or techniques similar to these techniques may be used.

FIG. 6 is a conceptual view showing an example of a coating method of binder particle groups. For example, coating with the binder particle groups may be performed by an electrostatic screen printing method. The binder particle groups 12 are arranged on a screen 101. The screen 101 is conductive. A plurality of through holes is formed in the screen 101. The current collector foil 11 is arranged under the screen 101. A power source 102 applies a direct current voltage to the space between the current collector foil 11 and the screen 101. As a result, an electric field (E) is formed between the screen 101 and the current collector foil 11. A charge (q) is injected into the binder particle groups 12 from the screen 101. That is, the binder particle groups 12 are charged. A printing brush 103 levels the binder particle groups 12, which makes the binder particle groups 12 introduced into the electric field. In the electric field, electrostatic force (F=qE) acts on the binder particle groups 12. Due to the electrostatic force, the binder particle groups 12 can be attached to the surface of the current collector foil 11. For example, the coating pattern can be controlled by the pattern of the through holes in the screen 101. That is, the binder particle groups 12 can be scattered in the desired form.

The coating thickness (deposition thickness) of the binder particle groups 12 may be, for example, 0.1 μm to 3 μm or 0.1 μm to 1 μm.

(c) Coating with Active Material Particle Groups

The present manufacturing method includes forming the active material layer 13 by coating the surface of the current collector foil 11 with active material particle groups (powder) after the coating with the binder particle groups 12.

The coating with active material particle groups can be performed by any method. For example, a slurry containing active material particle groups may be prepared. For example, the surface of the current collector foil 11 may be coated with the slurry by a die coater. For example, wet powder containing active material particle groups may be prepared. For example, the surface of the current collector foil 11 may be coated with the wet powder by a roll coater. The wet powder may also be called a granulated material.

The coating with active material particle groups may be performed by a dry method just as the coating with binder particle groups. It is considered that performing the coating with the active material particle groups by a dry method will make it easy to maintain the way the binder particle groups are scattered.

For example, active material particles, a conductive material, and a binder may be combined, so that composite particles are formed. In a case where coating with the composite particle groups (powder) is performed by a dry method, the active material layer 13 having a homogeneous composition can be formed. It is considered that this is because the positional relationship between the active material particles, the conductive material, and the binder is unlikely to change in the process of forming the active material layer 13. In the wet method, in the process of forming the active material layer 13, for example, a binder tends to move together with a solvent (liquid), which is likely to result in a non-homogeneous composition.

(d) Fixing

The present manufacturing method may include fixing the active material layer 13 to the current collector foil 11 by applying at least either heat or pressure to the active material layer 13. Fixing of the active material layer 13 to the current collector foil 11 is expected to improve peel strength.

The pressure and heat may be applied separately. The pressure and heat may be substantially simultaneously applied. For example, the active material layer 13 may be compressed by a heat roll or a heat plate. The heating temperature of the active material layer 13 may be, for example, a temperature close to the melting point of the binder. The heating temperature may be, for example, 80° C. to 200° C., 120° C. to 200° C., or 140° C. to 180° C.

The pressure can be adjusted, for example, according to the target thickness or target density of the active material layer 13. For example, a pressure of 50 MPa to 200 MPa may be applied to the active material layer 13.

Through the above process, the present electrode 10 can be manufactured. The present electrode 10 may be cut in a predetermined planar shape according to the specifications of a battery.

Manufacturing of Electrode

Electrodes of Nos. 1 to 5 were manufactured as below.

No. 1

The following materials were prepared.

Active material particle groups: Li(NiCoMn)O₂, range of particle size=3 μm to 10 μm

Conductive material: Acetylene black

Binder particle groups: PVdF, D50=150 nm, density=1.76 g/cm³

Current collector foil: Al foil, thickness=12 μm

An electrostatic screen printing machine (manufactured by Berg Co., Ltd.) was prepared. The distance between the screen 101 and the current collector foil 11 was set to 1 cm. A direct current voltage of 1.5 kV was applied to the space between the screen 101 and the current collector foil 11, thereby forming an electric field. By an electrostatic screen printing method, a surface of the current collector foil 11 was coated with the binder particle groups 12 (see FIG. 6). That is, the coating with the binder particle groups 12 was performed by a dry method. The basis weight of the binder particle groups 12 was 0.007 mg/cm². The coating thickness of the binder particle groups 12 was 0.5 μm.

A mixing device “Multipurpose Mixer” manufactured by NIPPON COKE & ENGINEERING CO., LTD. was prepared. The device includes a spherical tank (mixing tank). Due to the convection promoting effect of the spherical tank, strong shearing force is generated, which allows solid materials to be combined.

The active material particle groups, the conductive material, and the binder were put into the spherical tank. The mixing ratio of the materials was “active material particle groups/conductive material/binder=90/5/5 (mass ratio)”. The rotation speed of a stirring blade was set to 10,000 rpm. The materials were mixed together for 10 minutes. By the attachment of the conductive material and the binder to the surface of each of the active material particles, composite particles were formed.

By an electrostatic screen printing method (dry method), the surface of the current collector foil 11 was coated with the composite particle groups. In this way, the active material layer 13 was formed. That is, the present electrode 10 was manufactured.

The present electrode 10 was interposed between two sheets of heat plates (flat plates). The temperature of the heat plates was 160° C. By the heat plates, a load of 15 tf was applied to the active material layer 13. In this way, the active material layer 13 was fixed to the current collector foil 11.

Nos. 2 to 4

The manufacturing of the present electrode 10 and the fixing of the active material layer 13 were performed in the same manner as in No. 1, except that the basis weight of the binder particle groups 12 was changed as shown in the following Table 1.

No. 5

The binder particle groups were dissolved in a solvent, thereby preparing a binder solution. The surface of the current collector foil 11 was coated with the binder solution in the form of stripes (see FIGS. 3 and 4). In this way, the binder film 14 was formed. An electrode was manufactured in the same manner as in No. 1, except that the above procedure was carried out.

Evaluation of Electrode

By the 90-degree peel test, the peel strength between the active material layer 13 and the current collector foil 11 was measured.

By an electrode resistance measuring system (model name “RM2610”, manufactured by HIOKI E.E. CORPORATION), the interfacial resistance between the active material layer 13 and the current collector foil 11 was measured.

TABLE 1

| | | Binder | | | |
|---|---|---|---|---|---|
| | | particle groups ^{*)} | | Evaluation | |
| | | Basis | Area | Peel | Interfacial |
| | Coating | weight | fraction | strength | resistance |
| No. | method | [mg/cm²] | [%] | [N/m] | [Ω/cm²] |
| 1 | Dry method | 0.007 | 8.0 | 0.6 | Unmeasured |
| 2 | Dry method | 0.010 | 11.4 | 1 | 0.0011 |
| 3 | Dry method | 0.014 | 15.9 | 2.3 | 0.0020 |
| 4 | Dry method | 0.017 | 19.3 | 3.5 | 0.0033 |
| 5 | Wet method | 0.050 | 56.8 | 1 | 0.0135 |

^{*)} No. 5 is a binder film.

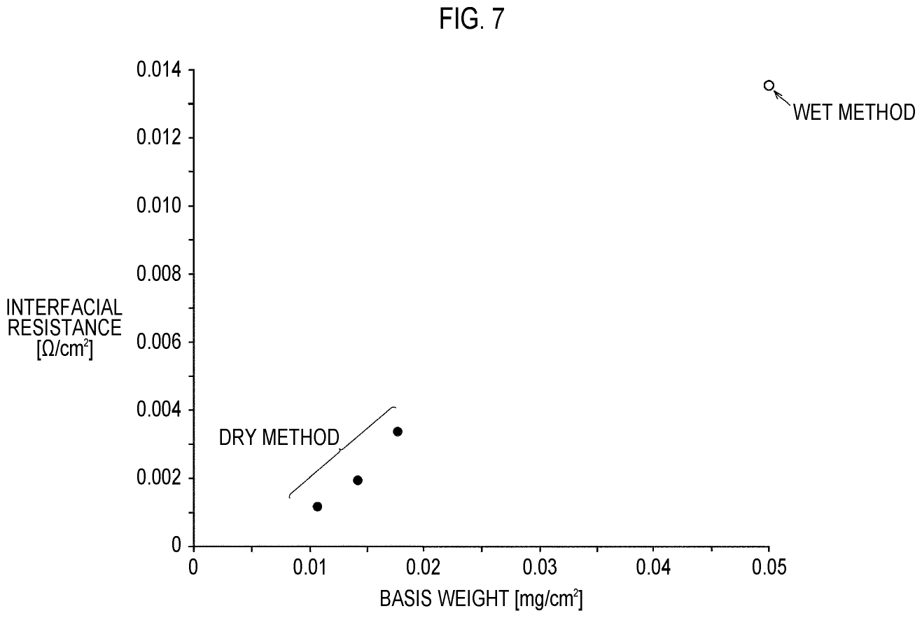

FIG. 7 is a graph showing the relationship between binder basis weight and interfacial resistance. As the basis weight increases, the interfacial resistance tends to increase.

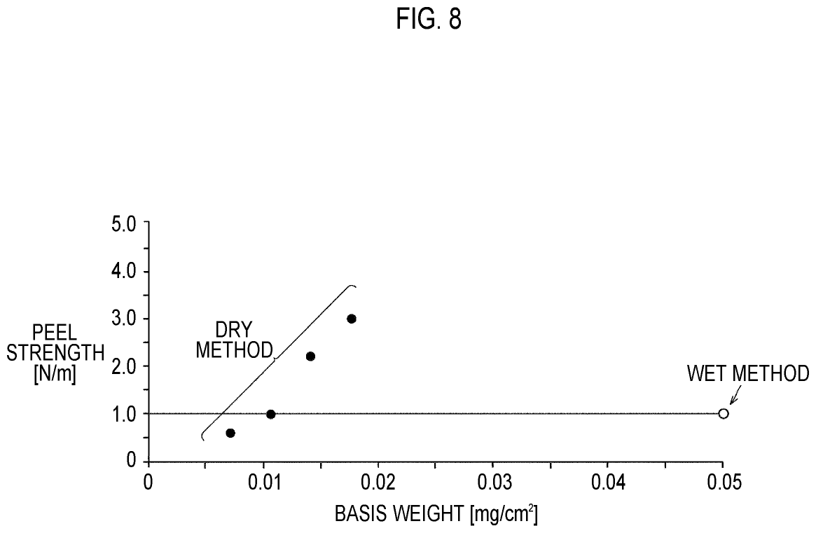

FIG. 8 is a graph showing the relationship between binder basis weight and peel strength. It has been revealed that performing coating with the binder particle groups by a dry method tends to result in a high peel strength with a small basis weight. That is, compared to the wet method, the dry method can further reduce the binder basis weight. Therefore, it is considered that performing coating with the binder particle groups by a dry method can mitigate the increase in interfacial resistance (see FIG. 7).

### ADDITIONAL REMARK

The present specification also supports a lithium ion battery. The lithium ion battery includes the present electrode. The lithium ion battery is expected to have low battery resistance. This is because the interfacial resistance between the active material layer and the current collector foil is low in the present electrode. The lithium ion battery may be a liquid-based battery or an all-solid-state battery.

The present embodiment and the present example are merely examples in all respects. The present embodiment and the present example are not restrictive. The technical scope of the present disclosure includes all modifications within the meaning and scope equivalent to the description of CLAIMS. For example, extracting arbitrary configurations from the present embodiment and present example and arbitrarily combining the configurations are preconceived from the first.

What is claimed is:

1. An electrode for a lithium ion battery, comprising:
a current collector foil;
binder particle groups; and
an active material layer, wherein
the binder particle groups are attached to a surface of the current collector foil;
the active material layer is arranged on the surface of the current collector foil;
the active material layer contains active material particle groups; and
the binder particle groups are scattered within an interface between the active material layer and the current collector foil.

2. The electrode according to claim 1, wherein a fraction of an area to which the binder particle groups are attached in an area of the current collector foil is 11.4% to 19.3%.

3. The electrode according to claim 1, wherein D50 of the binder particle groups is smaller than D50 of the active material particle groups.

4. The electrode according to claim 1, wherein a basis weight of the binder particle groups is 0.010 mg/cm² to 0.017 mg/cm².

5. A method of manufacturing an electrode for a lithium ion battery, the method comprising steps of:
(a) preparing a current collector foil;
(b) coating a surface of the current collector foil with binder particle groups by a dry method; and
(c) forming an active material layer by coating the surface of the current collector foil with active material particle groups after the step (b).

6. The method according to claim 5, wherein the step (b) includes attaching the binder particle groups to the surface of the current collector foil by electrostatic force.

7. The method according to claim 5, wherein the step (c) includes performing coating with the active material particle groups by a dry method.
